(19) United States
(12) Patent Application Publication
(10) Pub. No.: US 2025/0365721 A1
(43) Pub. Date: Nov. 27, 2025

(54) BEAM MANAGEMENT, CSI TRIGGERING, AND CSI-RS FRAMEWORK

(71) Applicant: Samsung Electronics Co., Ltd., Suwon-si (KR)

(72) Inventors: Mustafa Furkan Ozkoc, The Colony, TX (US); Young Han Nam, Plano, TX (US); Jianhua Mo, Allen, TX (US); Ahmad AlAmmouri, Richardson, TX (US); Hyejin Kim, Suwon-si (KR); Jeehwan Noh, Suwon-si (KR); TaeYoung Kim, Suwon-si (KR)

(21) Appl. No.: 19/092,985

(22) Filed: Mar. 27, 2025

Related U.S. Application Data
(60) Provisional application No. 63/651,825, filed on May 24, 2024.
(60) Provisional application No. 63/683,568, filed on Aug. 15, 2024.

(51) Int. Cl. H04W 72/044; H04B 7/06; H04L 5/00; H04W 24/10

(52) U.S. Cl. CPC H04W 72/046; H04B 7/0626; H04L 5/0048; H04W 24/10

(57) ABSTRACT

Apparatuses and methods for beam management, channel state information (CSI) triggering, and CSI reference signal (CSI-RS) framework. A method performed by a user equipment (UE) includes receiving, from a base station (BS), downlink control information (DCI) associated with a UE beam selection procedure and a CSI measurement procedure; determining, based on receipt of the DCI, to perform the UE beam selection procedure and the CSI measurement procedure; and performing, based on receipt of signals from the BS, the UE beam selection procedure and the CSI measurement procedure.

### CROSS-REFERENCE TO RELATED AND CLAIM OF PRIORITY

The present application claims priority under 35 U.S.C. § 119(e) to U.S. Provisional Patent Application No. 63/651,825 filed on May 24, 2024 and U.S. Provisional Patent Application No. 63/683,568 filed on Aug. 15, 2024, which are hereby incorporated by reference in their entirety.

### TECHNICAL FIELD

The present disclosure relates generally to wireless communication systems and, more specifically, the present disclosure is related to apparatuses and methods for beam management, channel state information (CSI) triggering, and CSI reference signal (CSI-RS) framework.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam management, CSI triggering, and CSI-RS framework.

In one embodiment, a user equipment (UE) is provided. The UE includes a transceiver configured to receive, from a base station (BS), downlink control information (DCI) associated with a UE beam selection procedure and a CSI measurement procedure. The UE further includes a processor operably coupled with the transceiver. The processor is configured to determine, based on receipt of the DCI, to perform the UE beam selection procedure and the CSI measurement procedure and perform, based on receipt of signals from the BS, the UE beam selection procedure and the CSI measurement procedure.

In another embodiment, a BS is provided. The BS includes a processor and a transceiver operably coupled with the processor. The transceiver is configured to transmit, to a UE, DCI associated with a UE beam selection procedure and a CSI measurement procedure and transmit, to the UE, signals for the UE beam selection procedure and the CSI measurement procedure.

In yet another embodiment, method performed by a UE is provided. The method includes receiving, from a BS, DCI associated with a UE beam selection procedure and a CSI measurement procedure; determining, based on receipt of the DCI, to perform the UE beam selection procedure and the CSI measurement procedure; and performing, based on receipt of signals from the BS, the UE beam selection procedure and the CSI measurement procedure.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise” as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of example beam management procedures according to embodiments of the present disclosure;

FIG. 7 illustrates a flowchart of an example procedure for beam management and CSI measurement according to embodiments of the present disclosure;

FIG. 8 illustrates a flowchart of an example procedure for beam management and CSI measurement according to embodiments of the present disclosure;

FIG. 9 illustrates a diagram of an example signaling for reporting CSI measurement according to embodiments of the present disclosure;

FIG. 10 illustrates a diagram of an example downlink control information (DCI) configuration according to embodiments of the present disclosure;

FIG. 11 illustrates a flowchart of an example procedure for beam management and CSI measurement according to embodiments of the present disclosure;

FIG. 12 illustrates a flowchart of an example procedure for beam management and CSI measurement according to embodiments of the present disclosure;

FIG. 13 illustrates a flowchart of an example procedure for transmitting radio resource control (RRC) configuration message according to embodiments of the present disclosure;

FIG. 14 illustrates a flowchart of an example procedure for beam management and CSI measurement according to embodiments of the present disclosure;

FIG. 15 illustrates a diagram of an example DCI configuration according to embodiments of the present disclosure;

FIG. 16 illustrates a flowchart of an example procedure for beam management and CSI measurement according to embodiments of the present disclosure; and

FIG. 17 illustrates an example method performed by a UE in a wireless communication system according to embodiments of the present disclosure.

### DETAILED DESCRIPTION

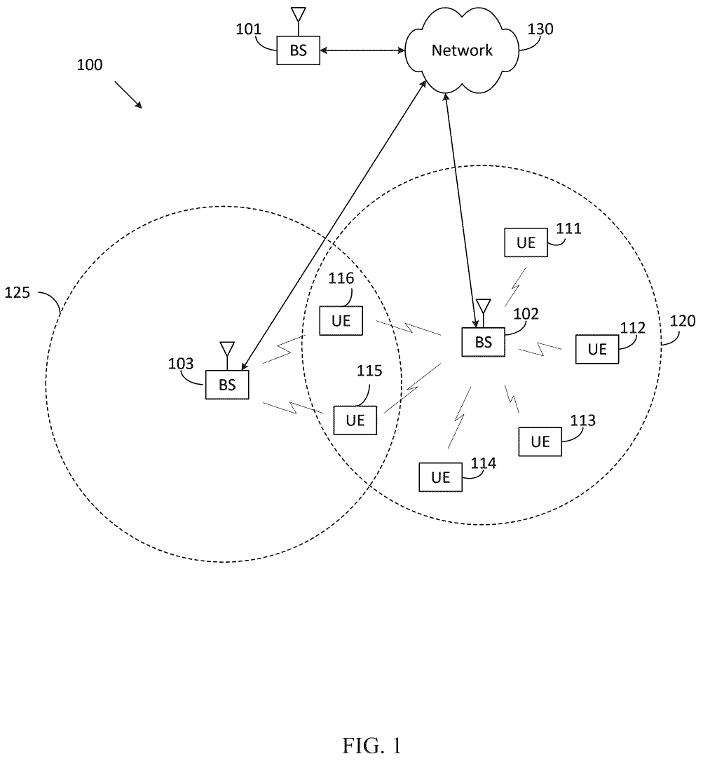

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam management, CSI triggering, and CSI-RS framework. In certain embodiments, one or more of the BSs 101-103 include circuitry, programing, or a combination thereof to support beam management, CSI triggering, and CSI-RS framework.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

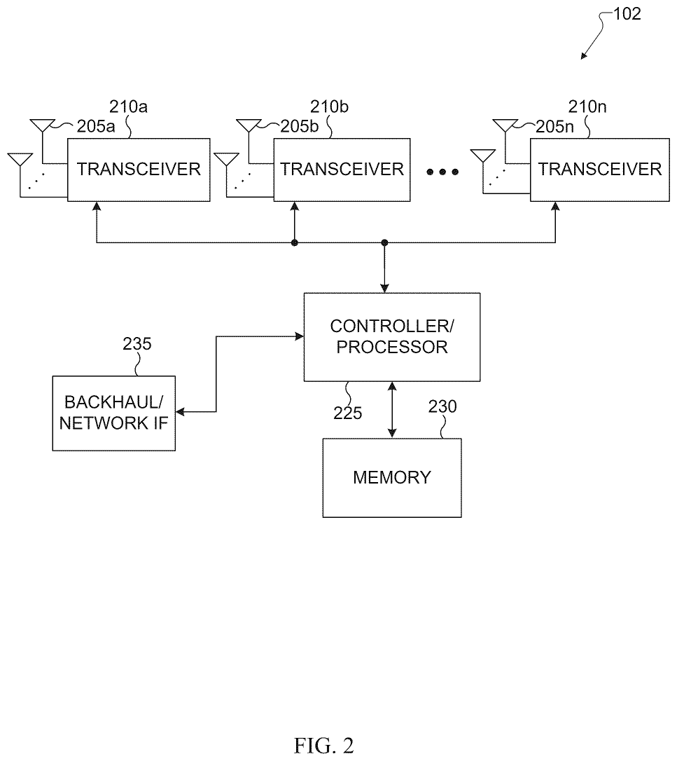

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for beam management, CSI triggering, and CSI-RS framework. Any of a wide variety of other functions could be supported in the gNB 102 by the controller/processor 225.

The controller/processor 225 is also capable of executing programs and other processes resident in the memory 230, such as processes for beam management, CSI triggering, and CSI-RS framework. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

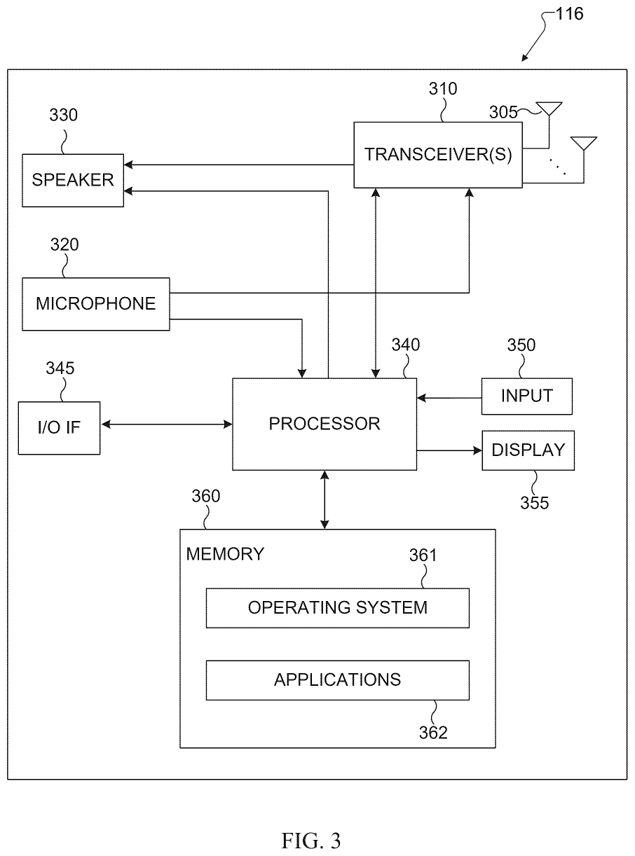

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam management, CSI triggering, and CSI-RS framework as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

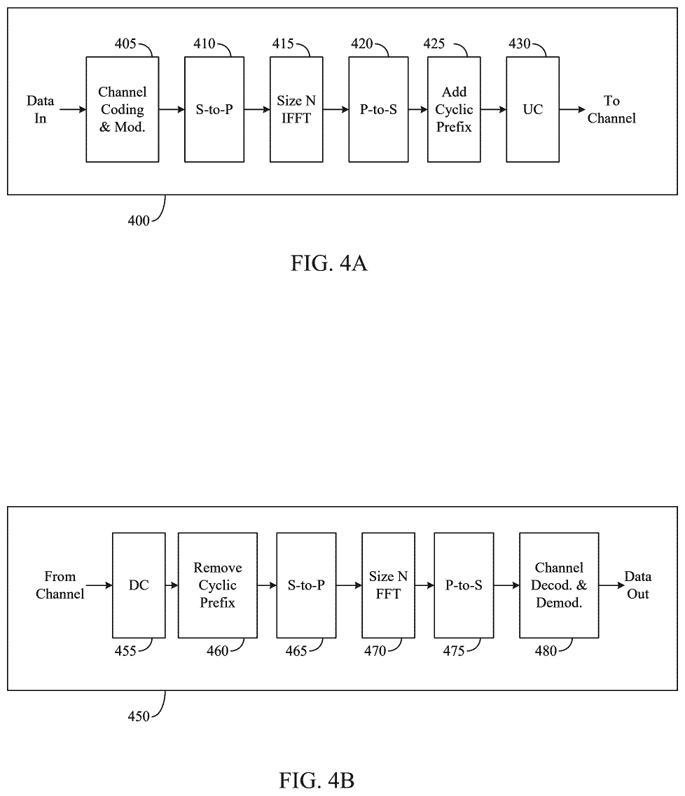

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 and or transmit path 400 is configured for supporting beam management, CSI triggering, and CSI-RS framework as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

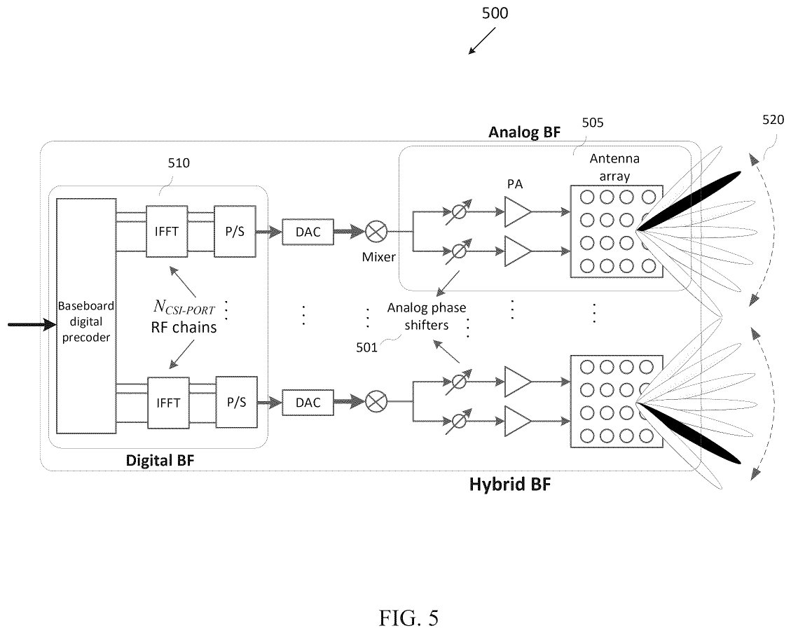

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) can be used to compensate for the additional path loss.

Embodiments of the present disclosure recognize that mmWave beam tracking is very important and challenging for the 5G mmWave base stations. Unlike the low-frequency bands, beamforming may be needed to support the high data transmission at the mmWave band due to the large mmWave band path loss. Many beams may be needed to cover a wide angular region, for example, horizontally from −60 degrees to +60 degrees may necessitate accurate beam tracking. To achieve accurate beam tracking many reference signals can be used to find the best beam between BS and UE. Various embodiments of the present disclosure provide methods to reduce the signaling overhead related to beam tracking. Furthermore, the UE CSI-RS measurement framework can impact the achieved spectral efficiency. This disclosure describes an example of UE CSI-RS measurement framework that could improve the achieved spectral efficiency.

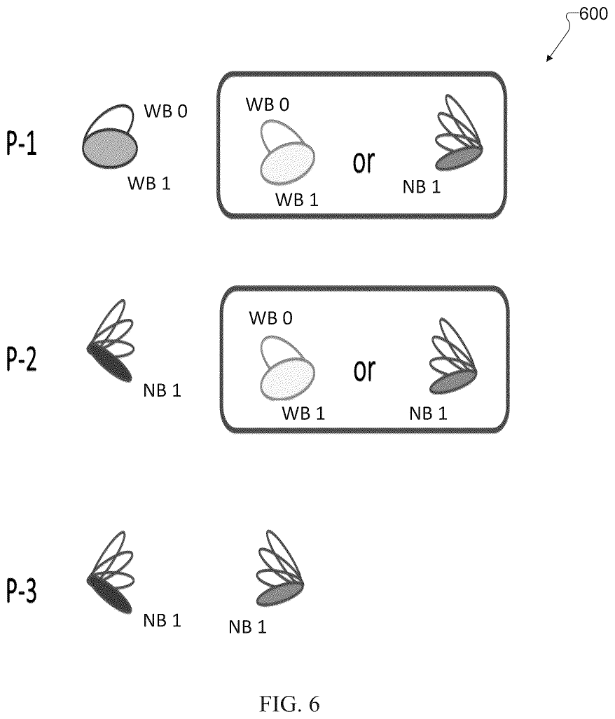

The mmWave beam management includes 3 procedures: P1, P2, and P3. In the P1 procedure, BS is sweeping its wide beams, while UE determines which wide beam is the best one. In P2, BS sweeps the narrow beams aligned or close to the wide beam found in P1, and UE determines the best narrow beam. In P3, BS repeats transmission on the narrow beam identified in P2, while UE sweeps its beams and decides its best beam to communicate with the BS. As used herein, in various embodiments, the P3 procedure may be referred to as a UE beam selection, beam management, or beam refinement procedure. FIG. 6 illustrates an example of the P3 procedure.

FIG. 6 illustrates a diagram of example beam management procedures 600 according to embodiments of the present disclosure. For example, beam management procedures 600 can be implemented by the BS 102 and any of the UEs 111-116 of FIG. 1. This example is for illustration only and other embodiments can be used without departing from the scope of the present disclosure.

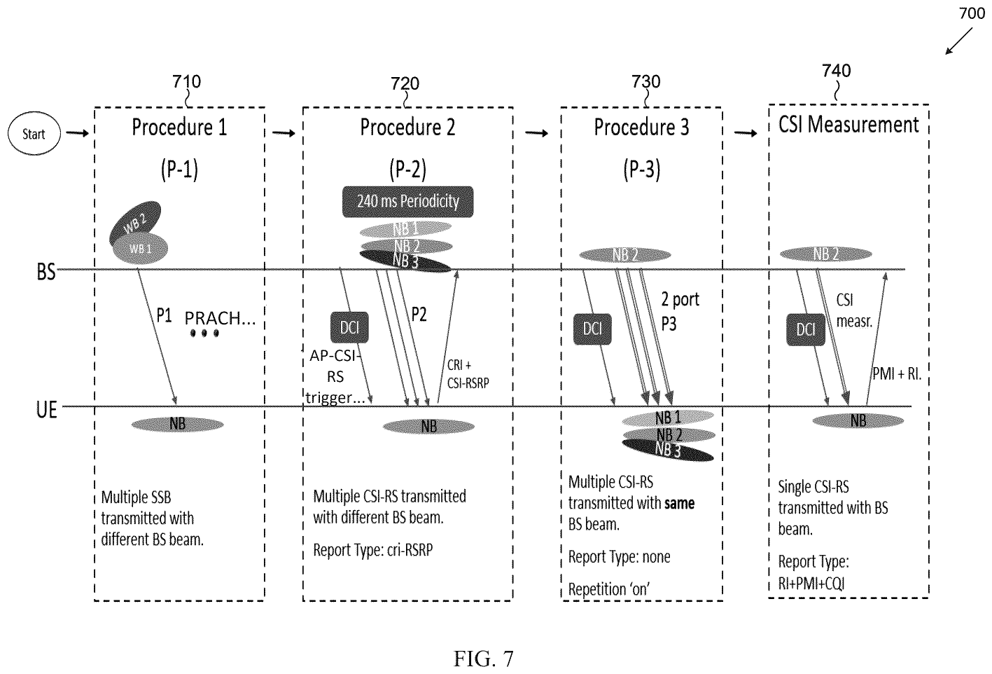

FIG. 7 illustrates a flowchart of an example procedure 700 for beam management and CSI measurement according to embodiments of the present disclosure. For example, procedure 700 can be performed by the UE 116 and the gNB 102 and/or network 130 in the wireless network 100 of FIG. 1. This example is for illustration only and other embodiments can be used without departing from the scope of the present disclosure.

The procedure begins in 710, a BS is sweeping its wide beams, while UE determines which wide beam is the best one. In various embodiments, multiple synchronization signal blocks (SSBs) may be transmitted with a different BS beam. In 720, the BS sweeps the narrow beams aligned or close to the wide beam found in 710 and UE determines the best narrow beam. In various embodiments, multiple CSI-RSs may be transmitted with a different BS beam. In 730, the BS repeats transmission on the narrow beam identified in 720 while UE sweeps its beams and decides its best beam to communicate with the BS. In various embodiments, multiple CSI-RSs may be transmitted with a different BS beam. In 740, the UE performs CSI measurement. In various embodiments, a single CSI RS may be transmitted with a BS beam.

Embodiments of the present disclosure recognize that the P3 procedure incurs overhead in the downlink. Embodiments of the present disclosure also recognize that there is downlink control channel overhead due to the DCI triggering the P3 procedure and downlink shared channel overhead due to the resource allocation to the P3 CSI-RS signaling. In addition, the P3 procedure is executed for every user. When there are many users, the P3 overhead could significantly reduce the downlink throughput. One example of the baseline signaling framework is illustrated in FIG. 6.

Accordingly, various embodiments of the present disclosure provide for:
1. Triggering, via a base station, a P3 procedure, and a CSI measurement with a common control signal.
2. Transmission, via a base station, set of CSI-RS for P3 and CSI-RS for CSI with a sufficient time gap in between
3. Causing a compatible UE to determine its optimal receiver beam by sweeping its own beams during P3 CSI-RS reception, and causing a compatible UE to receive the next CSI-RS for the CSI measurement by the optimal receiver beam determined during P3.
4. Causing a compatible UE to determine its optimal receiver beam by sweeping its own beams during CSI-RS reception, causing a compatible UE to complete the CSI measurement for its optimal receiver beam, and causing a compatible UE to report the CSI measurement result.
5. Transmission, via a base station, a common CSI-RS resource set facilitating P-3 and CSI measurement.

Embodiments in this disclosure relate to methods to reduce the overhead of triggering the P3 and CSI measurement procedures. Although mmWave bands are used as an example in this disclosure, the embodiments can also be applied to other frequency bands.

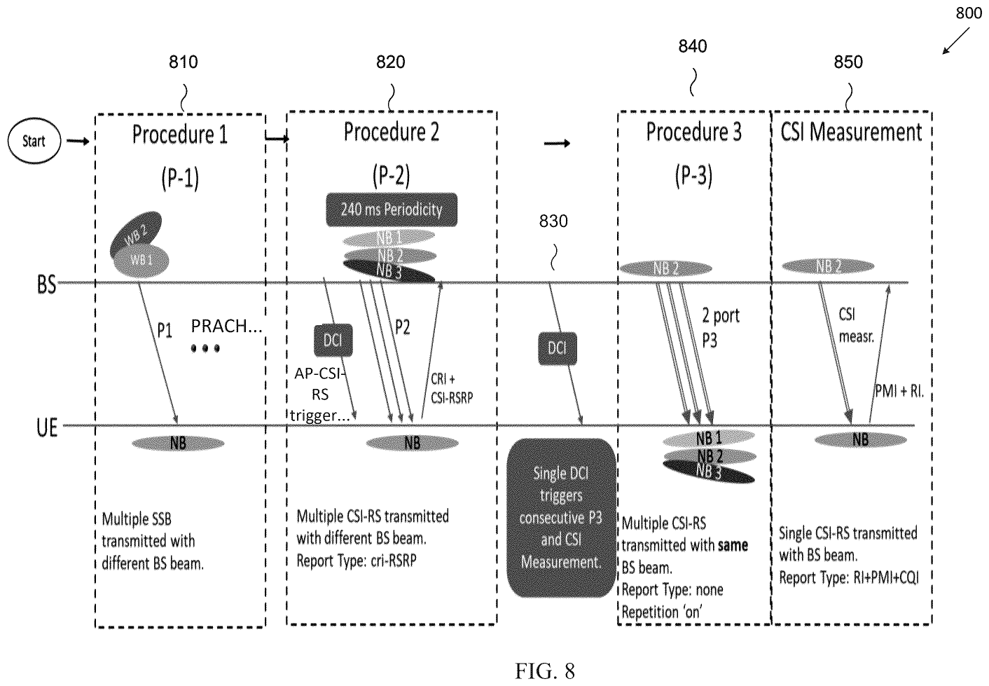

FIG. 8 illustrates a flowchart of an example procedure 800 for beam management and CSI measurement according to embodiments of the present disclosure. For example, procedure 800 can be performed by the UE 111 and the gNB 102 and/or network 130 in the wireless network 100 of FIG. 1. This example is for illustration only and other embodiments can be used without departing from the scope of the present disclosure.

The procedure begins in 810, a BS is sweeping its wide beams, while UE determines which wide beam is the best one. In various embodiments, multiple SSBs may be transmitted with a different BS beam. In 820, the BS sweeps the narrow beams aligned or close to the wide beam found in 810 and UE determines the best narrow beam. In various embodiments, multiple CSI-RSs may be transmitted with a different BS beam. In 830, a single DCI triggers consecutive P3 and CSI measurement. In 840, the BS repeats transmission on the narrow beam identified in 820 while UE sweeps its beams and decides its best beam to communicate with the BS. In various embodiments, multiple CSI-RSs may be transmitted with the same BS beam. In 850, the UE performs CSI measurement. In various embodiments, a single CSI RS may be transmitted with a BS beam.

In one embodiment, the BS could trigger the P3 procedure and CSI measurement with a common control signal. For example, the common control signal could be a DCI format 0_1 signal. FIG. 8 illustrates one example of the signaling framework that triggers P3 and CSI using common DCI.

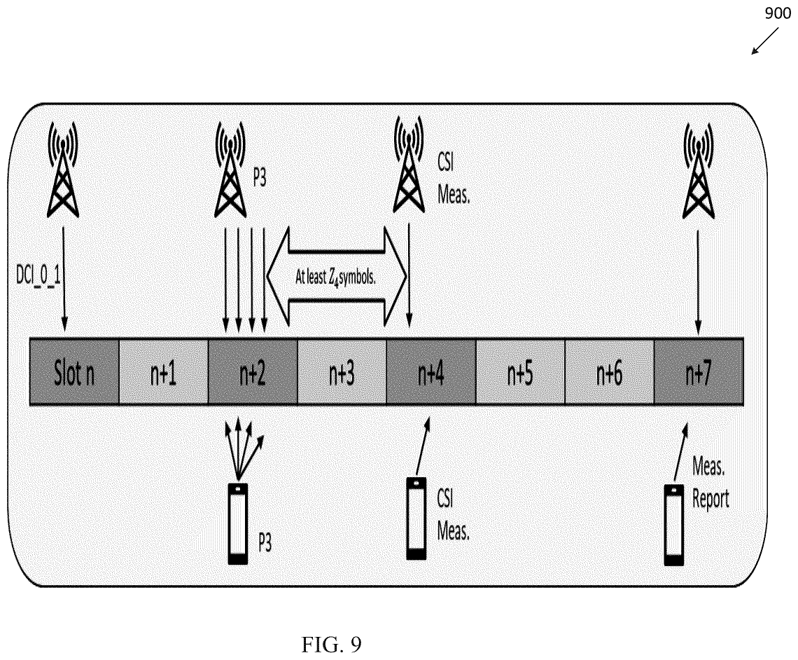

FIG. 9 illustrates a diagram of an example signaling 900 for reporting CSI measurement according to embodiments of the present disclosure. For example, signaling 900 can be implemented by the UE 116 and the gNB 103 and/or network 130 in the wireless network 100 of FIG. 1. This example is for illustration only and other embodiments can be used without departing from the scope of the present disclosure.

With reference to FIG. 9, a UE behavior is shown. A common trigger state could be defined as one that triggers both the P3 procedure and CSI measurement using a common DCI, therefore reducing the control signaling overhead. Accompanying the common trigger, a desired UE behavior could improve the overall spectral efficiency. A compatible UE (e.g., the UE 116) could determine its best receiver beam by sweeping its beams during P3 CSI-RS signaling. Following P3 CSI-RS signals, a CSI-RS for CSI measurement could be transmitted by the BS. If the UE could update its receiver beam in a timely manner with the best beam identified during P3 to receive the CSI-RS for CSI, it could determine the rank and precoding matrix with its new receiver beam. Following the CSI-RS for CSI, the UE could report the most up-to-date CSI to the base station. Overall, a higher-quality CSI report could enable higher spectral efficiency.

One manner of describing this UE behavior in relevant standard specifications (e.g., Clause 5.2.1.6 of TS 38.214) while maintaining compatibility with typical users is as follows: “A trigger state is initiated using the CSI request field in DCI.
When the configured trigger state includes two CSI-ReportConfigs, the reportQuantity field of one CSI-ReportConfig is set as ‘none’ and the associated NZP-CSI-RS-Resource Set is configured with repetition field set as ‘on’, and the reportQuantity field of another CSI-ReportConfig is set as ‘cri-RI-LI-PMI-CQI’, the UE shall provide a valid CSI report.
   If the first symbol of the aperiodic CSI-RS-Resource Set of CSI-ReportConfig with reportQuantity set to ‘cri-RI-LI-PMI-CQI’ starts no earlier than Z₄ symbols from the last symbol of the aperiodic CSI-RS-ResourceSet of CSI-ReportConfig of ‘none’, where Z₄ is defined in table 5.4-2.

Furthermore, a table with an additional column Z₄, where the duration is described for various frame structure numerologies, is provided (e.g., as an update to Table 5.4-2 in specification TS 38.214). One example of such addition is included in TABLE 1.

TABLE 1

Z₄ [symbols]

| μ | | Z₄ | Z′₄ |
|---|---|---|---|
| 0 | . . . | 1 | 1 |
| 1 | | 2 | 2 |
| 2 | | 4 | 4 |
| 3 | | 8 | 8 |
| 4 | | 16 | 16 |
| 5 | | 32 | 32 |
| 6 | | 64 | 64 |

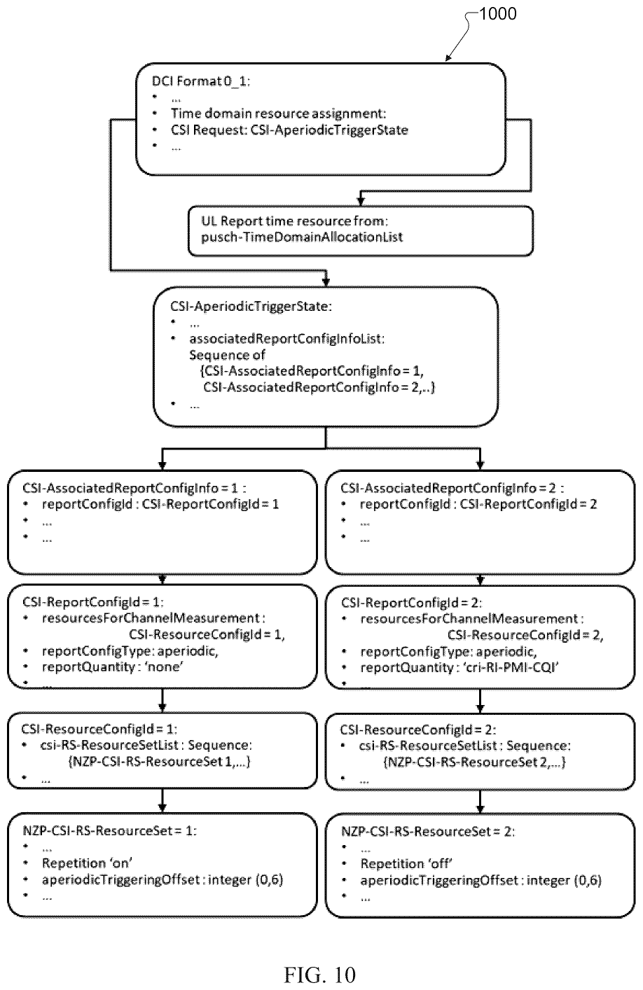

FIG. 10 illustrates a diagram of an example DCI configuration 1000 according to embodiments of the present disclosure. For example, DCI configuration 1000 can be configured by the BS 102 of FIG. 2. This example is for illustration only and other embodiments can be used without departing from the scope of the present disclosure.

With reference to FIG. 10, one example is shown of over the air signaling. In one example, the CSI-AperiodicTriggerState field indicated in DCI format 0_1 could have an associatedReportConfigInfoList. Upon receiving the value associated with a trigger state, the UE will measure CSI-RS, CSI-IM, and/or SSB (reference signals) and aperiodic reporting on L1 according to entries in the associatedReportConfigInfoList for that trigger state. With reference to FIG. 9, one example is shown of the CSI-RS framework that triggers both the P3 procedure and CSI with a common DCI signaling.

In one example, associatedReportConfigInfoList field for that trigger state could include at least two entries of associated report configuration information of CSI-AssociatedReportConfigInfo. One CSI-AssociatedReportConfigInfo could provide information about the P3 procedure, and another could provide information for CSI measurement.

In one example, the CSI-AssociatedReportConfigInfo that provides information about the P3 procedure could include reportConfigId field with a CSI-ReportConfigId. The CSI-ReportConfigId could be associated with a CSI-ReportConfig. The CSI-ReportConfig could include resourcesForChannelMeasurement field with a CSI-ResourceConfigId and reportQuantity field with choice of ‘none’. The CSI-ResourceConfigId could be associated with a CSI-ResourceConfig. The CSI-ResourceConfig could include a field with csi-RS-ResourceSetList which includes NZP-CSI-RS-ResourceSetId. The NZP-CSI-RS-ResourceSetId could be associated with a CSI-RS-ResourceSet. The CSI-RS-ResourceSet could include a repetition field set as ‘on’.

In one example, the CSI-AssociatedReportConfigInfo that provides information about the CSI procedure could include reportConfigId field with a CSI-ReportConfigld. The CSI-ReportConfigId could be associated with a CSI-ReportConfig. The CSI-ReportConfig could include resourcesForChannelMeasurement field with a CSI-ResourceConfigId and reportQuantity field with choice of ‘cri-RI-PMI-CQI’. The CSI-ResourceConfigId could be associated with a CSI-ResourceConfig. The CSI-ResourceConfig could include a field with csi-RS-ResourceSetList which includes NZP-CSI-RS-ResourceSetId. The NZP-CSI-RS-ResourceSetId could be associated with a CSI-RS-ResourceSet. The CSI-RS-ResourceSet could include a repetition field set as ‘off’.

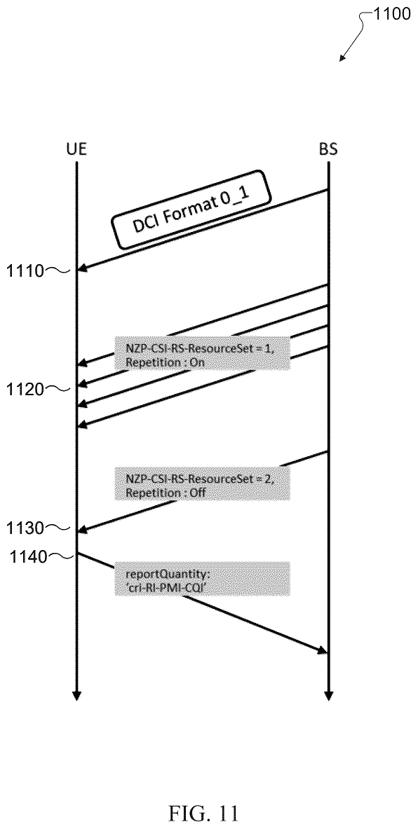

FIG. 11 illustrates a flowchart of an example procedure 1100 for beam management and CSI measurement according to embodiments of the present disclosure. For example, procedure 1100 can be performed by the UE 112 and the gNB 102 and/or network 130 in the wireless network 100 of FIG. 1. This example is for illustration only and other embodiments can be used without departing from the scope of the present disclosure.

The procedure begins in 1110, a BS transmits a DCI Format 0_1 to a UE. In 1120, the BS transmits a resource set configuration to the UE. In various embodiments, the BS may transmit one or more NZP-CSI-RS-Resourceset=1 to the UE. In 1130, the BS transmits another resource set configuration to the UE. In 1140, the UE transmits a report to the BS.

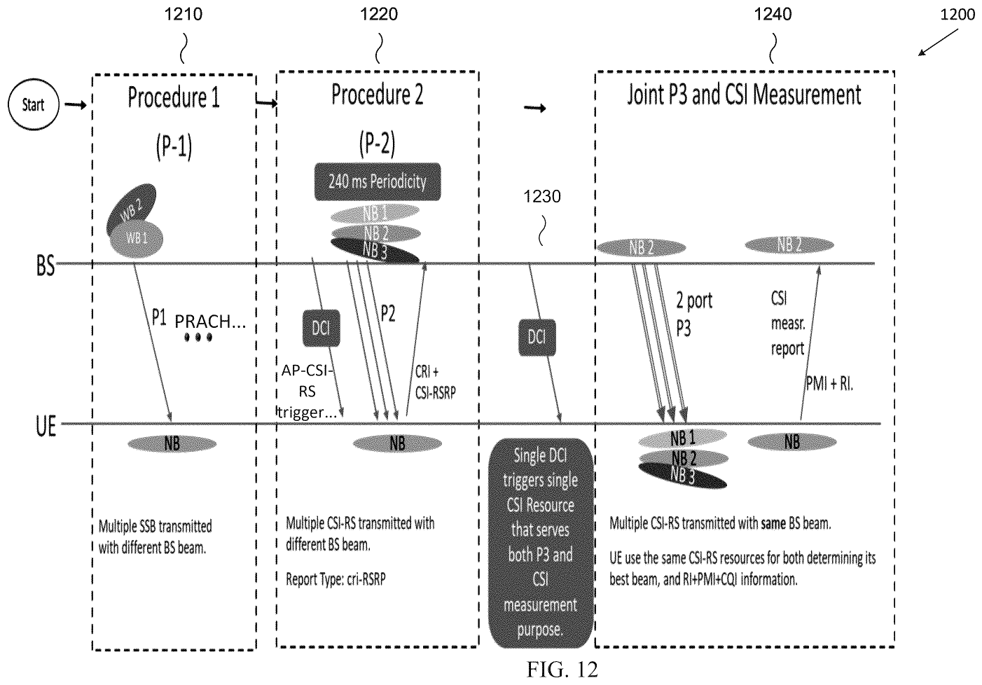

FIG. 12 illustrates a flowchart of an example procedure 1200 for beam management and CSI measurement according to embodiments of the present disclosure. For example, procedure 1200 can be performed by the UE 113 and the gNB 102 and/or network 130 in the wireless network 100 of FIG. 1. This example is for illustration only and other embodiments can be used without departing from the scope of the present disclosure.

The procedure begins in 1210, a BS is sweeping its wide beams, while UE determines which wide beam is the best one. In various embodiments, multiple SSBs may be transmitted with a different BS beam. In 1220, the BS sweeps the narrow beams aligned or close to the wide beam found in 1210 and UE determines the best narrow beam. In various embodiments, multiple CSI-RSs may be transmitted with a different BS beam. In 1230, a single DCI triggers a single CSI resource that serves both P3 and CSI measurement purposes. In 1240, the BS repeats transmission on the narrow beam identified in 1220 while UE sweeps its beams and decides its best beam to communicate with the BS. In various embodiments, multiple CSI-RSs may be transmitted with the same BS beam. Additionally in 1240, the UE performs CSI measurement. In various embodiments, multiple CSI RS may be transmitted with the same BS beam. In various embodiments, the UE uses the same CSI-RS resources for both determining its best beam and RI, PMI, and CQI information.

In one embodiment, a BS could reduce overhead by transmitting common CSI-RS resources and facilitating a UE's sweep of beams and measurement of channel state through the common CSI-RS set. This would avoid the overhead of separate CSI-RS transmission, specifically the additional CSI-RS signaling for CSI measurement. FIG. 12 illustrates common CSI-RS resources for P-3 and CSI measurement procedures.

The UE capabilities could be different when measuring CSI-RS(s).
i. In one UE implementation, the UE sweeps its beams and buffer the channel estimates for each swept beam. The UE can determine its best beam through a performance indicator, i.e., reference signal received power (RSRP) values and spectral efficiency estimates. Once the UE identified its best beam, the CSI measurement and report quantities could be computed using the buffered estimates for the resource corresponding to its best beam. The UE could then report the cri-RI-PMI-CQI back to the BS.
ii. In another UE implementation, the UE may be unable to buffer channel estimates and sweep its beams. The BS should not transmit common CSI-RS resources for P-3 and CSI measurement in such scenarios.

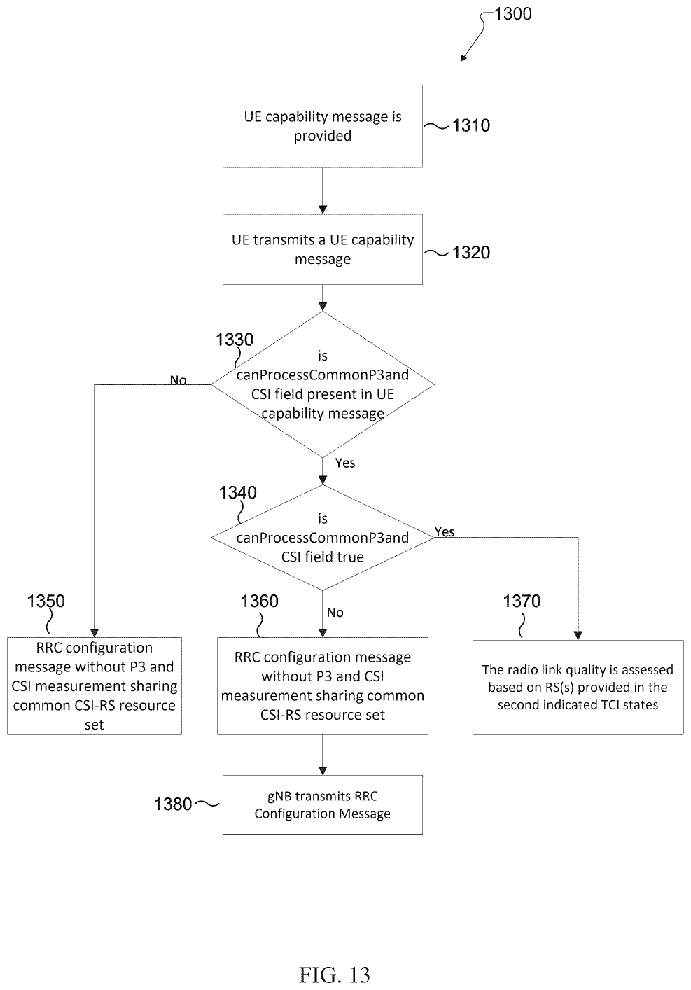

FIG. 13 illustrates a flowchart of an example procedure 1300 for transmitting RRC configuration message according to embodiments of the present disclosure. For example, procedure 1300 can be performed by the UE 114 and the gNB 102 and/or network 130 in the wireless network 100 of FIG. 1. This example is for illustration only and other embodiments can be used without departing from the scope of the present disclosure.

In one example, whether the UE can measure P-3 and CSI-RS through the same CSI-RS resource set capability can be indicated to the BS through an optional field, canProcessCommonP3andCSI. If the optional field is true, the UE indicates its capability of processing the P-3 and CSI Measurement through a common set of CSI-RS resources. If the optional field is false or not included, the UE shall not be expected to process P-3 and CSI measurement through a common set of CSI-RS resources. FIG. 13 illustrates one example of the UE capability and relevant RRC configuration flow.

The procedure begins in 1310, a UE capability message is provided. In 1320, a UE transmits a UE capability message. In 1330, it is determined whether canProcessCommonP3andCSI field is present in UE capability message. If canProcessCommonP3andCSI field is not present, then in 1350, RRC configuration message is without P3 and CSI measurement sharing common CSI-RS resource set. In 1380, the gNB transmits RRC configuration message. If canProcessCommonP3andCSI field is present, then in 1340, it is determined whether the canProcessCommonP3andCSI field is true. If the canProcessCommonP3andCSI field is not true, then in 1360, RRC configuration message is without P3 and CSI measurement sharing common CSI-RS resource set. Then in 1380, the gNB transmits RRC configuration message. If the canProcessCommonP3andCSI field is true, then in 1370, RRC configuration message is with P3 and CSI measurement sharing common CSI-RS resource set. Then in 1380, the gNB transmits RRC configuration message.

Different UE implementations could have different CSI-RS(s) processing criteria. The UE indicates the number of supported simultaneous CSI calculations N_{CPU} with parameter simultaneousCSI-ReportsPerCC in a component carrier, and simultaneousCSI-ReportsAllCC across component carriers. If a UE supports N_{CPU} simultaneous CSI calculations it is said to have N_{CPU} CSI processing units for processing CSI reports.

In one embodiment, the BS could determine whether the UE can sweep its beams and perform CSI measurement through a common CSI-RS resource set using the UE calculation capability information. If there are K_{S} CSI-RS resources in the CSI-RS resource set for P-3 and channel measurement, and the UE has N_{CPU} larger than K_{S}, the UE could be able to complete its beam sweeping and channel measurement report.

In another embodiment, a UE can explicitly indicate the maximum number of supported CSI-RS resources in the CSI-RS set for P-3 and channel measurement,

$${N}_{CPU}^{( P - 3 , CSI )} .$$

According to the indicated value the BS can facilitate common P-3 and

CSI measurement with a resource set containing fewer CSI-RS resources than the indicated

$${N}_{CPU}^{( P - 3 , CSI )}$$

value. In some networks, the maximum CSI-RS resources the BS can allocate for CSI-RS resource set for P-3 and channel measurement

$${K}_{{s}_{m ax}}^{( P - 3 , CSI )}$$

could be less than

$${N}_{CPU}^{( P - 3 , CSI )}$$

of some UEs. In such scenarios, the BS could facilitate the measurement with minimum of either value,

$$min ( {N}_{CPU}^{( P - 3 , CSI )} , {K}_{{s}_{m ax}}^{( P - 3 , CSI )} ) .$$

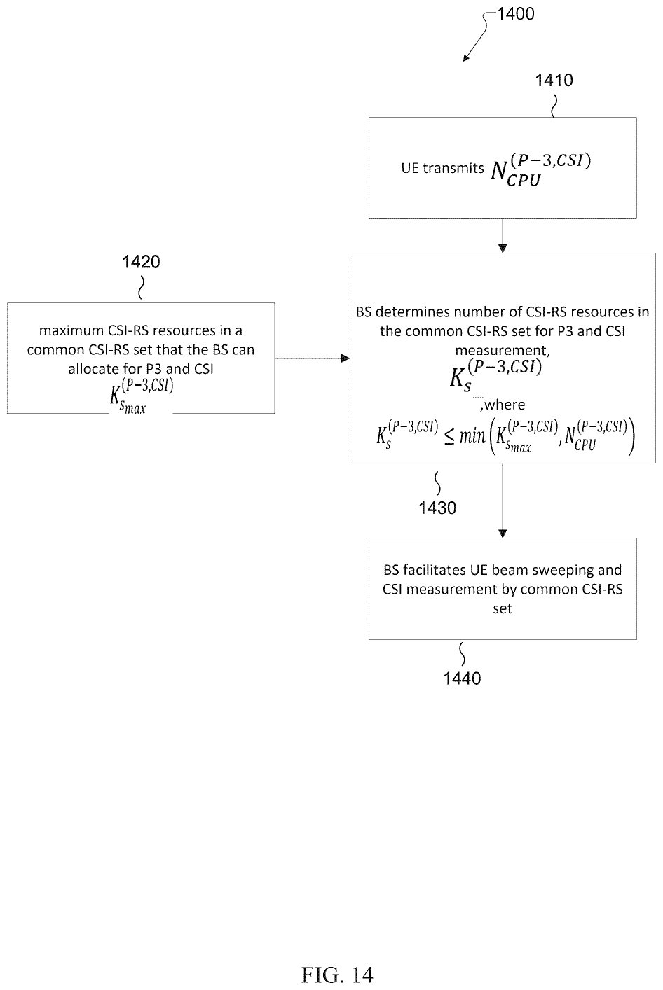

FIG. 14 illustrates a flowchart of an example procedure 1400 for beam management and CSI measurement according to embodiments of the present disclosure. For example, procedure 1400 by the UE 115 and the gNB 102 and/or network 130 in the wireless network 100 of FIG. 1. This example is for illustration only and other embodiments can be used without departing from the scope of the present disclosure.

With reference to FIG. 14, one example is shown of a CSI-RS framework to facilitate a common CSI-RS resource set for P-3 and CSI measurement. The procedure begins in 1410, a UE transmits

$${N}_{CPU}^{( P - 3 , CSI )} .$$

In 1420 maximum CSI-RS resources in a common CSI-RS set that the BS can allocate for P3 and

$$CSI {K}_{{s}_{m ax}}^{( P - 3 , CSI )}$$

is provided. In 1430, the BS determines a number of CSI-RS resources in the common CSI-RS set for P3 and CSI measurement

$${K}_{s}^{( P - 3 , CSI )} \leq min ( {K}_{{s}_{ma x}}^{( P - 3 , CSI )} , {N}_{CPU}^{( P - 3 , CSI )} ) .$$

In 1440, the BS facilitates UE beam sweeping and CSI measurement by common CSI-RS set.

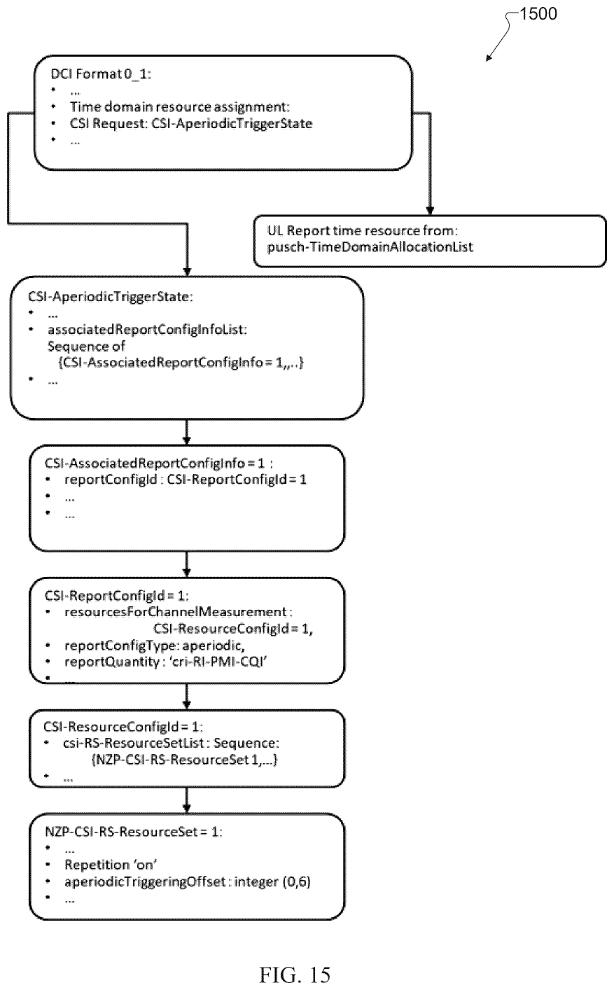

FIG. 15 illustrates a diagram of an example DCI configuration 1500 according to embodiments of the present disclosure. For example, DCI configuration 1500 can be configured by the BS 103 of FIG. 1. This example is for illustration only and other embodiments can be used without departing from the scope of the present disclosure. With reference to FIG. 15, one example is shown of the air signaling between the BS and UE, where a common CSI-RS resource set is used for P-3 and CSI measurement.

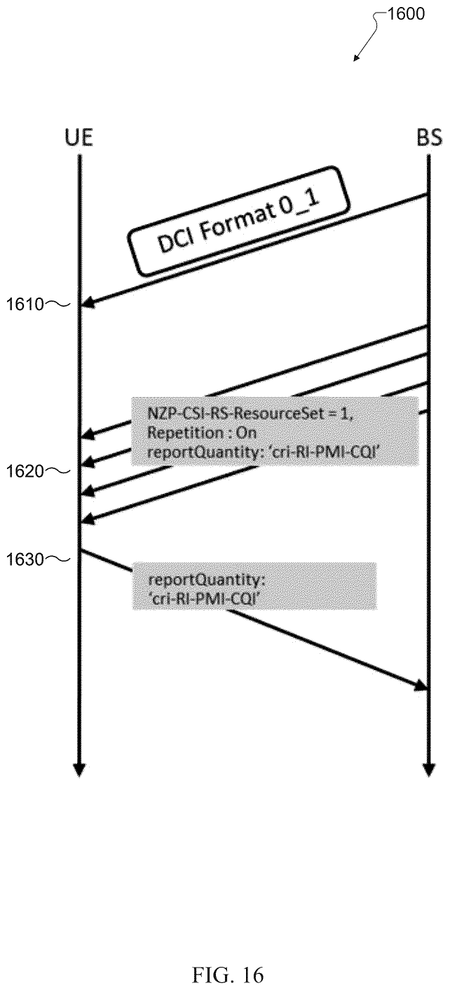

FIG. 16 illustrates a flowchart of an example procedure 1600 for beam management and CSI measurement according to embodiments of the present disclosure. For example, procedure 1600 by the UE 116 and the gNB 102 and/or network 130 in the wireless network 100 of FIG. 1. This example is for illustration only and other embodiments can be used without departing from the scope of the present disclosure.

The procedure begins in 1610, a BS transmits a DCI Format 0_1 to a UE. In 1620, the BS transmits a resource set configuration to the UE. In various embodiment, the BS may send other configurations and/or information to the UE. In 1630, the UE transmits a report to the BS.

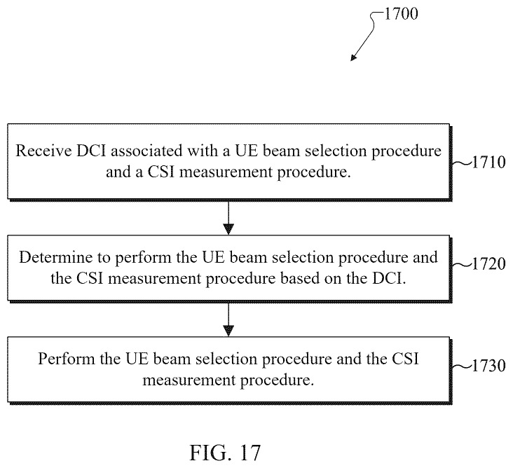

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving DCI associated with a UE beam selection procedure and a CSI measurement procedure (1710). For example, in 1710, the DCI may be received from a BS, such as, BS 101. In some examples, the UE beam selection procedure may be a UE beam refinement procedure or a P3 procedure as described herein, while the CSI measurement procedure may be for CSI reporting after UE beam selection or refinement.

The UE then determines to perform the UE beam selection procedure and the CSI measurement procedure based on the DCI (1720). For example, in 1720, the DCI may instruct and/or configure both the UE beam selection procedure and the CSI measurement procedure to reduce associated signaling overhead as opposed to separate configuration messages being sent for the UE beam selection and CSI measurement procedures

Thereafter, the UE performs the UE beam selection procedure and the CSI measurement procedure (1730). For example, in 1730, the UE performs the beam selection procedure and the CSI measurement procedure based on receipt of signals from the BS, which may be a single or common set of RSs during one time instance to perform both procedures or may be separate sets of RSs received during different time instances for the respective procedures.

For example, in various embodiments, the UE identifies, based on the DCI, a first set of CSI-RSs for the UE beam selection procedure and a second CSI-RS for the CSI measurement procedure and performs the UE beam selection procedure based on receipt of the first set of CSI-RSs from the BS to determine a UE beam based on the UE beam selection procedure. For example, the DCI may indicate or configure the different CSI-RSs or time instances for the CSI-RSs for the respective procedure. Thereafter, the UE performs the CSI measurement procedure based on receipt of the second CSI-RS from the BS using the determined UE beam.

In various embodiments, the UE generates a CSI report when a first symbol of a CSI-RS for the CSI measurement procedure starts no earlier than a predetermined time duration from a last symbol of a CSI-RS for UE beam selection procedure. In other words, the UE is expected and/or able to generate the CSI report by virtue of having enough time to perform the UE beam selection or refinement prior to CSI-RS measurement by virtue of this predetermined time duration between the respective RS receptions.

In various embodiments, the UE identifies, based on the DCI, a common set of CSI-RSs for the UE beam selection procedure and the CSI measurement procedure and perform, based on repetitions of CSI-RSs in the common set, the UE beam selection procedure and the CSI measurement procedure. For example, the UE may receive repetition over time and perform the UE beam selection procedure and the CSI measurement procedure successively using the repetitions of the RSs received over time.

In various embodiments, the UE may perform both the UE beam selection procedure and the CSI measurement procedure using a single set of received RSs. For example, the UE may receive repetitions of CSI-RSs in a common set of CSI-RSs for the UE beam selection procedure and the CSI measurement procedure, determine a UE beam based on reception of the repetitions of the CSI-RSs using different UE beams, respectively, store CSI measurement information associated with measurements of the repetitions of the CSI-RSs received using the different UE beams, respectively, after determination of the UE beam, identify, from among the stored CSI measurement information, information associated with measurement of the determined UE beam, and then generate the CSI report based on the information associated with measurement of the determined UE beam.

In various embodiments, the UE may determine whether the UE can perform or is capable of performing the UE beam selection procedure and the CSI measurement procedure using the common set of CSI-RSs and transmit, to the BS, information indicating whether the UE can perform the UE beam selection procedure and the CSI measurement procedure using the common set of CSI-RSs.

In various embodiments, whether the UE can perform the UE beam selection procedure and the CSI measurement procedure using a common set of CSI-RSs may be implicitly or semi-implicitly indicated. For example, the capability indication may be based on a quantity of CSI-RS resources for the UE in a CSI-RS resource set for the UE beam selection procedure and a number of simultaneous CSI calculations supported by the UE.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each FIG. could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive, from a base station (BS), downlink control information (DCI) associated with a UE beam selection procedure and a channel state information (CSI) measurement procedure; and
a processor operably coupled with the transceiver, the processor configured to:
determine, based on receipt of the DCI, to perform the UE beam selection procedure and the CSI measurement procedure; and
perform, based on receipt of signals from the BS, the UE beam selection procedure and the CSI measurement procedure.

2. The UE of claim 1, wherein the processor is further configured to:
identify, based on the DCI, a first set of CSI reference signals (CSI-RSs) for the UE beam selection procedure and a second CSI-RS for the CSI measurement procedure,
perform the UE beam selection procedure based on receipt of the first set of CSI-RSs from the BS,
determine a UE beam based on the UE beam selection procedure, and
perform the CSI measurement procedure based on receipt of the second CSI-RS from the BS using the determined UE beam.

3. The UE of claim 1, wherein the processor is further configured to generate a CSI report when a first symbol of a CSI reference signal (CSI-RS) for the CSI measurement procedure starts no earlier than a predetermined time duration from a last symbol of a CSI-RS for UE beam selection procedure.

4. The UE of claim 1, wherein the processor is further configured to:
identify, based on the DCI, a common set of CSI reference signals (CSI-RSs) for the UE beam selection procedure and the CSI measurement procedure, and
perform, based on repetitions of CSI-RSs in the common set, the UE beam selection procedure and the CSI measurement procedure.

5. The UE of claim 1, wherein:
the transceiver is further configured to receive repetitions of CSI reference signals (CSI-RSs) in a common set of CSI-RSs for the UE beam selection procedure and the CSI measurement procedure;
to perform the UE beam selection procedure, the processor is further configured to determine a UE beam based on reception of the repetitions of the CSI-RSs using different UE beams, respectively; and
to perform the CSI measurement procedure, the processor is further configured to:
store CSI measurement information associated with measurements of the repetitions of the CSI-RSs received using the different UE beams, respectively,
after determination of the UE beam, identify, from among the stored CSI measurement information, information associated with measurement of the determined UE beam, and
generate a CSI report based on the information associated with measurement of the determined UE beam.

6. The UE of claim 1, wherein:
the processor is further configured to determine whether the UE can perform the UE beam selection procedure and the CSI measurement procedure using a common set of CSI reference signals (CSI-RSs); and
the transceiver is further configured to transmit, to the BS, information indicating whether the UE can perform the UE beam selection procedure and the CSI measurement procedure using the common set of CSI-RSs.

7. The UE of claim 1, wherein whether the UE can perform the UE beam selection procedure and the CSI measurement procedure using a common set of CSI reference signals (CSI-RSs) is based on (i) a quantity of CSI-RS resources for the UE in a CSI-RS resource set for the UE beam selection procedure and (ii) a number of simultaneous CSI calculations supported by the UE.

8. A base station (BS), comprising:
a processor; and
a transceiver operably coupled with the processor, the transceiver configured to:
transmit, to a user equipment (UE), downlink control information (DCI) associated with a UE beam selection procedure and a channel state information (CSI) measurement procedure; and
transmit, to the UE, signals for the UE beam selection procedure and the CSI measurement procedure.

9. The BS of claim 8, wherein:
the DCI indicates a first set of CSI reference signals (CSI-RSs) for the UE beam selection procedure and a second CSI-RS for the CSI measurement procedure, and
the transceiver is further configured to:
transmit, to the UE, the first set of CSI-RSs for the UE beam selection procedure, and
transmit, to the UE, the second CSI-RS for the CSI measurement procedure for reception based on a UE beam determined from the UE beam selection procedure.

10. The BS of claim 8, wherein the UE generates a CSI report when a first symbol of a CSI reference signal (CSI-RS) for the CSI measurement procedure starts no earlier than a predetermined time duration from a last symbol of a CSI-RS for UE beam selection procedure.

11. The BS of claim 8, wherein:
the DCI indicates a common set of CSI reference signals (CSI-RSs) for the UE beam selection procedure and the CSI measurement procedure, and
the transceiver is further configured to transmit, to the UE, repetitions of CSI-RSs in the common set, for the UE beam selection procedure and the CSI measurement procedure.

12. The BS of claim 8, wherein the transceiver is further configured to:
transmit repetitions of CSI reference signals (CSI-RSs) in a common set of CSI-RSs for the UE beam selection procedure and the CSI measurement procedure; and
receive, from the UE, a CSI report for the CSI measurement procedure based on the common set of CSI-RSs.

13. The BS of claim 8, wherein the transceiver is further configured to receive, from the UE, information indicating whether the UE can perform the UE beam selection procedure and the CSI measurement procedure using a common set of CSI reference signals (CSI-RSs).

14. The BS of claim 8, wherein whether the UE can perform the UE beam selection procedure and the CSI measurement procedure using a common set of CSI reference signals (CSI-RSs) is based on (i) a quantity of CSI-RS resources for the UE in a CSI-RS resource set for the UE beam selection procedure and (ii) a number of simultaneous CSI calculations supported by the UE.

15. A method performed by a user equipment (UE), the method comprising:
receiving, from a base station (BS), downlink control information (DCI) associated with a UE beam selection procedure and a channel state information (CSI) measurement procedure;
determining, based on receipt of the DCI, to perform the UE beam selection procedure and the CSI measurement procedure; and
performing, based on receipt of signals from the BS, the UE beam selection procedure and the CSI measurement procedure.

16. The method of claim 15, further comprising:
identifying, based on the DCI, a first set of CSI reference signals (CSI-RSs) for the UE beam selection procedure and a second CSI-RS for the CSI measurement procedure,
wherein performing the UE beam selection procedure further comprises:
performing the UE beam selection procedure based on receipt of the first set of CSI-RSs from the BS, and
determining a UE beam based on the UE beam selection procedure; and
wherein performing the CSI measurement procedure further comprises performing the CSI measurement procedure based on receipt of the second CSI-RS from the BS using the determined UE beam.

17. The method of claim 15, wherein performing the CSI measurement procedure further comprises generating a CSI report when a first symbol of a CSI reference signal (CSI-RS) for the CSI measurement procedure starts no earlier than a predetermined time duration from a last symbol of a CSI-RS for UE beam selection procedure.

18. The method of claim 15, further comprising:
identifying, based on the DCI, a common set of CSI reference signals (CSI-RSs) for the UE beam selection procedure and the CSI measurement procedure,
wherein performing the UE beam selection procedure and the CSI measurement procedure further comprises performing, based on repetitions of CSI-RSs in the common set, the UE beam selection procedure and the CSI measurement procedure.

19. The method of claim 15, further comprising:
receiving repetitions of CSI reference signals (CSI-RSs) in a common set of CSI-RSs for the UE beam selection procedure and the CSI measurement procedure,
wherein performing the UE beam selection procedure further comprises determining a UE beam based on reception of the repetitions of the CSI-RSs using different UE beams, respectively; and
wherein performing the CSI measurement procedure further comprises:
storing CSI measurement information associated with measurements of the repetitions of the CSI-RSs received using the different UE beams, respectively,
after determination of the UE beam, identifying, from among the stored CSI measurement information, information associated with measurement of the determined UE beam, and
generating a CSI report based on the information associated with measurement of the determined UE beam.

20. The method of claim 15, further comprising:
determining whether the UE can perform the UE beam selection procedure and the CSI measurement procedure using a common set of CSI reference signals (CSI-RSs); and
transmitting, to the BS, information indicating whether the UE can perform the UE beam selection procedure and the CSI measurement procedure using the common set of CSI-RSs.
